(19) United States
(12) Patent Application Publication
(10) Pub. No.: US 2021/0208307 A1
(43) Pub. Date: Jul. 8, 2021

(54) TRAINING A MACHINE LEARNING ALGORITHM AND PREDICTING A VALUE FOR A WEATHER DATA VARIABLE, ESPECIALLY AT A FIELD OR SUB-FIELD LEVEL

(71) Applicant: BASF Agro Trademarks GmbH, Ludwigshafen am Rein (DE)

(72) Inventors: Eva Hill, Langenfeld (DE); Holger Hoffmann, Langenfeld (DE); Priyamvada Shankar, Langenfeld (DE); Ole Peters, Langenfeld (DE); Mirwaes Wahabzada, Langenfeld (DE); Christian Kerkhoff, Langenfeld (DE)

(21) Appl. No.: 17/056,556

(22) PCT Filed: May 24, 2019
(86) PCT No.: PCT/EP2019/063439

§ 371 Date: Nov. 18, 2020

(30) Foreign Application Priority Data
May 25, 2018 (EP) 18174325.3

(51) Int. Cl. G01W 1/10; G01W 1/02; G06N 3/08

(52) U.S. Cl. CPC G01W 1/10; G06N 3/08; G01W 1/02

(57) ABSTRACT

The invention relates to training a machine learning algorithm and predicting a value for a weather data variable, preferably at a field or sub-field level. In this respect, according to the invention, a method for predicting a value for at least one weather data variable for at least one instant of time in the future, is provided, the method comprising the following method steps: feeding a machine learning algorithm with a predicted weather dataset that comprises at least one predicted value for the said at least one weather data variable for the said at least one instant of time in the future and for at least one grid point of a first grid covering at least a part of the Earth's surface, feeding the machine learning algorithm with an observed environmental dataset that comprises at least one ground truth value for at least one environmental data variable for at least one grid point of a second grid covering at least the said part of the Earth's surface, and outputting by the machine learning algorithm a predicted value for the said at least one weather data variable for the said at least one instant of time in the future. In this way, a possibility for field specific weather predictions for providing field zone specific treatment recommendations at a small-meshed grid level may be provided.

The invention relates to a method for training a machine learning algorithm, comprising the method steps of feeding the machine learning algorithm with a predicted weather dataset that comprises at least one predicted value for at least one weather data variable for at least one instant of time and for at least one grid point of a grid covering at least a part of the Earth's surface, and feeding the machine learning algorithm with an observed weather dataset that comprises at least one ground truth value for the said at least one weather data variable for the said at least one instant of time and for at least one grid point of another grid covering at least the said part of the Earth's surface. The invention further relates to a method for predicting a value for at least one weather data variable for at least one instant of time in the future, comprising the method steps of feeding a machine learning algorithm with a predicted weather dataset that comprises at least one predicted value for the said at least one weather data variable for the said at least one instant of time in the future and for at least one grid point of a first grid covering at least a part of the Earth's surface, and outputting by the machine learning algorithm a predicted value for the said at least one weather data variable for the said at least one instant of time in the future.

Weather forecast today is not precise enough for field zone specific treatment recommendations. Conventional weather forecasts are made at a 13 km×13 km grid, i.e. ZIP-code level and, hence, are not effective for providing field zone specific treatment recommendations. The current state of the climate system including the atmosphere, land and ocean is characterized by various meteorological parameters, e.g. solar radiation, temperature, atmospheric pressure, wind velocity and direction, precipitation etc. Modern measurement and observing systems like weather radars and satellites generate fast and continuous meteorological (mass) data. Still, the classical meteorological hut holding measurement capacities for the aforementioned parameters forms the backbone of synoptic meteorology and weather forecasting due to its high precision.

However, one is usually not only interested in the current state of the climate system but also in its future evolution. Therefore, atmospheric scientists have developed numerical models, e.g. climate and numerical weather prediction (NWP) models, that forecast various climatic parameters for future time points and vast numbers of geo-locations. These models are typically discretized versions of the governing equations of the climate systems and encompass e.g. the Navier-Stokes equations for the conservation of momentum using discretization both in space and time. In doing so, a grid is imposed onto both axes defining a two-dimensional surface. In this way, the atmosphere is e.g. cut into cubes and then the Navier-Stokes equations are solved numerically on this grid.

Since those equations involve partial derivatives initial states and boundary conditions need to be prescribed. Initial states are usually stemming, e.g. from re-analyses including observations and a data assimilation step to derive pseudo observations at the model grid. Boundary conditions are e.g. the height of the atmosphere and the depth of the oceans.

Educated agronomic decision making heavily depends on accurate, hyperlocal/in-field weather information, especially with sub-field variation of agricultural practice, considering differences between parts of the field. However, farmers typically lack this critical source of data, weather forecasts for field zones are often biased and lack accuracy since the NWP grid spacing is usually in the order of 10 to 100 km. Therefore, forecasts represent spatial averages over domains with an edge length of minimum 10 km. On the other hand, weather stations typically gather very accurate data at a single point but lack spatial extension.

According to WO 2017/156325 A, a computer receives an observation dataset that identifies one or more ground truth values of an environmental variable at one or more times and a reforecast dataset that identifies one or more predicted values of the environmental variable produced by a forecast model that correspond to the one or more times. The computer then trains a climatology on the observation dataset to generate an observed climatology and trains the climatology on the reforecast dataset to generate a forecast climatology. The computer identifies observed anomalies by subtracting the observed climatology from the observation dataset and forecast anomalies by subtracting the forecast climatology from the reforecast dataset. The computer then models the observed anomalies as a function of the forecast anomalies, resulting in a calibration function, which the computer can then use to calibrate new forecasts received from the forecast model.

Further, in WO 2017/099951 A1 a system for detecting clouds and cloud shadows is described. In one approach, clouds and cloud shadows within a remote sensing image are detected through a three-step process. In the first stage a high-precision low-recall classifier is used to identify cloud seed pixels within the image. In the second stage, a low-precision high-recall classifier is used to identify potential cloud pixels within the image. Additionally, in the second stage, the cloud seed pixels are grown into the potential cloud pixels to identify clusters of pixels which have a high likelihood of representing clouds. In the third stage, a geometric technique is used to determine pixels which likely represent shadows cast by the clouds identified in the second stage. The clouds identified in the second stage and the shadows identified in the third stage are then exported as a cloud mask and shadow mask of the remote sensing image.

It is the object of the invention to provide a possibility for field specific weather predictions for providing field zone specific treatment recommendations at a small-meshed grid level, i.e. at a at a field or sub-field level.

This object is addressed by the subject matter of the independent claims. Preferred embodiments are described in the sub claims.

Therefore, according to the invention, a method for training a machine learning algorithm is provided, the method comprising the following method steps:
feeding the machine learning algorithm with a predicted weather dataset that comprises at least one predicted value for at least one weather data variable for at least one instant of time and for at least one grid point of a first grid covering at least a part of the Earth's surface,
feeding the machine learning algorithm with an observed environmental dataset that comprises at least one ground truth value for at least one environmental data variable for the said at least one instant of time and for at least one grid point of a second grid covering at least the said part of the Earth's surface, and
feeding the machine learning algorithm with an observed weather dataset that comprises at least one ground truth value for the said at least one weather data variable for the said at least one instant of time and for at least one grid point of a third grid covering at least the said part of the Earth's surface.

Hence, according to the invention, three grids are used which all cover at least a common part of the Earth's surface. For at least one grid point of the first grid, the machine learning algorithm is fed with a predicted weather dataset that comprises at least one predicted value for at least one weather data variable for at least one instant of time. Here, the term “weather data variable” relates to any variable which may be used as a weather parameter, i.e. which indicates at least some characteristics of weather. According to a preferred embodiment of the invention, the weather data variable of the predicted weather data set as well as the weather data variable of the observed weather data set are at least one of air temperature, air pressure, humidity, near-ground wind speed and/or direction.

Further, for at least one grid point of a second grid, the machine learning algorithm is also fed with an observed environmental dataset that comprises at least one ground truth value for at least one environmental data variable for the said at least one instant of time. Here, the term “environmental data variable” means all types of weather data variable as described above and, beyond that any parameter which may be used to characterize the environment of a certain place on Earth. According to a preferred embodiment of the invention, the at least one ground truth value for at least one environmental data variable of the observed environmental dataset is at least one of air temperature, air pressure, humidity, near-ground wind speed and/or direction (windward/leeward side of a point of reference), type of land cover and use (trees, hedges, fields, water, buildings, forest areas and woodlands, agricultural areas, grassland, irrigated areas, deserts and urban areas, . . . ), crop management practice (planting direction, . . . ), sun angle, topographic data (slope orientation, elevation, . . . ), and soil color. Further, the term “ground truth value” relates to the fact that this value has actually been measured/observed on or near the surface of the Earth, i.e. that it is a true and not only a predicted or assumed value.

By feeding the machine learning algorithm with the predicted weather dataset that comprises at least one predicted value for at least one weather data variable for at least one instant of time and for at least one grid point of the first grid and with the observed environmental dataset that comprises at least one ground truth value for at least one environmental data variable for the said at least one instant of time and for at least one grid point of the second grid the machine learning algorithm has already receive information about a certain weather prediction and a corresponding ground truth value for at least one environmental data variable within a common area of the Earth's surface. Further, by feeding the machine learning algorithm with an observed weather dataset that comprises at least one ground truth value for the said at least one weather data variable for the said at least one instant of time and for at least one grid point of the third grid, the machine learning algorithm also receives information which relate to what value, compared to the prediction, the weather data variable actually had. As are result, the machine learning algorithm may consider relationships of these three variable, e.g. how a predicted value may deviate from an actually observed value in dependence of characteristics of the environment. In this way, local environmental factors which may influence weather predictions may be taken into account for local weather forecasts.

In general, the distances between the grid points of the first grid, second grid and third grid may be chosen in different ways. However, according to a preferred embodiment of the invention, the second grid is less sparse than the first grid, i.e. the distances between the grid points of the second grid is smaller than the distances of the grid points of the first grid. For example the first grid may be a grid with grid points at 13 km×13 km. In contrast to such long distances between the grid points of the first grid, the grid points of the second grid may be at 1 km×1 km, at 500 m×500, or even at 100 m×100 m. In this way, environmental factors may be taken into account for a weather forecast at a very small-meshed grid level, i.e. at a at a field or sub-field level.

In general, the grid points of the different grids do not have to be identical. Actually, there may be separate grid points for each grid. This also applies to the first grid and the third grid. However, according to a preferred embodiment of the invention, the first grid and the third grid have common grid points which means that at least some grid points are common. Preferably, such a common grid point is a place on the Earth's surface where a weather station is located. Further, according to a preferred embodiment of the invention, the grids are chosen in such a way that the said at least one grid point of the first grid is different from the said at least one grid point of the second grid.

Furthermore, according to a preferred embodiment of the invention, the predicted weather dataset comprises predicted values for multiple weather data variables for multiple instants of time and for multiple grid points of the first grid, the observed environmental dataset comprises multiple ground truth values for multiple environmental data variables for the said multiple instants of time and for multiple grid points of the second grid, and the observed weather dataset comprises multiple ground truth values for the said multiple weather data variables for the said multiple instants of time and for multiple grid points of the third grid.

The invention may be used together with predicted weather dataset which are based on different weather prediction models. However, according to a preferred embodiment of the invention, the predicted weather dataset is based on a numerical weather prediction model, e.g. ICON, ICON-EU, COSMO-DE, and/or COSMO-DE EPS. Further, the observed environmental dataset is preferably based on an in-situ measurement and/or on capturing radar and/or satellite images. While different types of machine learning may be applied by the invention, the machine learning algorithm is preferably provided by an artificial neural network, and even more preferably an artificial neural network with hidden layers for deep learning.

Further, according to the invention, a method for predicting a value for at least one weather data variable for at least one instant of time in the future is provided, the method comprising the following method steps:
feeding a machine learning algorithm with a predicted weather dataset that comprises at least one predicted value for the said at least one weather data variable for the said at least one instant of time in the future and for at least one grid point of a first grid covering at least a part of the Earth's surface,
feeding the machine learning algorithm with an observed environmental dataset that comprises at least one ground truth value for at least one environmental data variable for at least one grid point of a second grid covering at least the said part of the Earth's surface, and
outputting by the machine learning algorithm a predicted value for the said at least one weather data variable for the said at least one instant of time in the future.

Hence, this method according to the invention relates to the prediction of a weather data variable using information of a predicted weather dataset that comprises at least one predicted value, and information of an observed environmental dataset that comprises at least one ground truth value for at least one environmental data variable. In this way, local weather forecast which take into account environmental characteristics become possible at a small-meshed grid level. Therefore, preferably the machine learning algorithm has been trained according to the method for training a machine learning algorithm as described above, beforehand.

According to a preferred embodiment, the at least one ground truth value for the said at least one environmental data variable for the said at least one grid point of the second grid is determined in real-time. This may enhance the accuracy of the prediction. Further preferred embodiments of the method for predicting a value for at least one weather data variable relate to the preferred embodiments of the method for training a machine learning algorithm as described above.

The invention also relates to a non-transitory computer-readable medium, comprising instructions stored thereon, that when executed on a processor, perform the steps of a method as described above.

Further, the invention also relates to a data processing system, comprising a processor and a non-transitory computer readable medium as described above.

These and other aspects of the invention will be apparent from and elucidated with reference to the embodiments described hereinafter. Such an embodiment does not necessarily represent the full scope of the invention, however, and reference is made therefore to the claims and herein for interpreting the scope of the invention.

In the drawings:

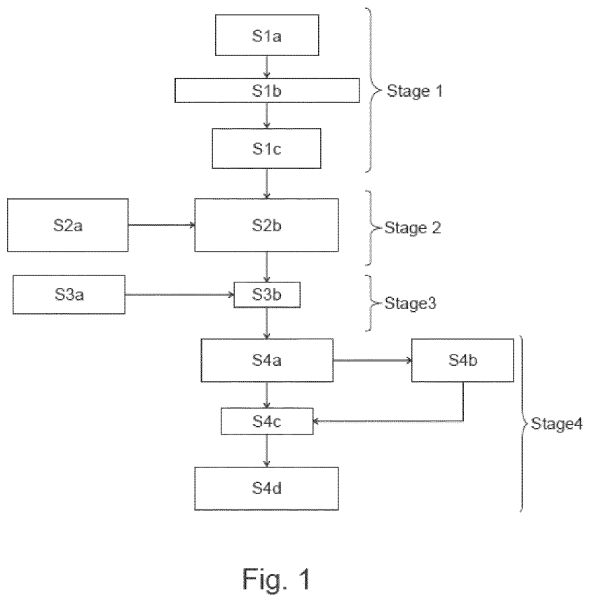

FIG. 1 schematically depicts a method of predicting field zone weather information according to a preferred embodiment of the invention.

In order to get field specific weather predictions, according to a preferred embodiment of the invention, a top down weather forecast down to a certain grid is provided. In this way, a weather data service is made available that provides local/field-specific weather parameters and predictions based on computer algorithms that fuse and enrich data from computer simulations, e.g. climate or numerical weather prediction models, and ground truth observations, e.g. in-situ measurements, radars or satellite images, using approaches from machine learning and statistics, e.g. clustering, dimension reduction, neural nets, deep learning, very deep learning, time series analysis, regression models, Gaussian processes, Markov models, and kriging.

In statistics, originally in geostatistics, kriging or Gaussian process regression is a method of interpolation for which the interpolated values are modeled by a Gaussian process governed by prior covariances, as opposed to a piecewise-polynomial spline chosen to optimize smoothness of the fitted values. Under suitable assumptions on the priors, kriging gives the best linear unbiased prediction of the intermediate values. Interpolating methods based on other criteria such as smoothness need not yield the most likely intermediate values. The method is widely used in the domain of spatial analysis and computer experiments. The technique is also known as Wiener-Kolmogorov prediction, after Norbert Wiener and Andrey Kolmogorov.

Hence, the present approach uses an integration of numeric (top down) and empiric (bottom up) model components in a hierarchically structured modeling chain to deliver retrospective high resolution simulation of climate parameters (daily and monthly), short- and mid term forecasts of weather conditions (e.g. 14 day, as 6-hourly and daily data) and optional simulations for alternative climate scenarios, e.g. daily and/or monthly.

The method steps of the preferred embodiment of the invention are schematically depicted in FIG. 1. The method comprises four main stages with several steps (steps S1a to S4d), as described in detail in the following.

The first stage comprises a first step in which data from an external service provider like Deutscher Wetterdienst (DWD) or the European Centre for Medium Range Weather Forecasting (ECMWF) is gathered (step S1a). This data comprises observational data from e.g. weather station networks and simulated data from re-analyses or forecast models like ICON (Icosahedral Nonhydrostatic Model). This data is preprocessed and prepared in a conventional way (step S1b) in order to provide a global forecast data layer of 13 km×13 km grid as known from the prior art (step S1c).

A great number of environmental factors affect weather at different scales. Hence, according to the preferred embodiment of the invention, in a second stage environmental data is taken into account in order to prepare field zone specific weather predictions.

One of the most important triggers of orographic effects is the near ground wind field which is mainly driven by topography and land cover and land use. Among others, environmental influence factors include the windward or leeward side of a point of reference, the proximity of water bodies in windward direction to a point of reference, canopy and land cover including in-field elements or field surroundings such as trees and hedges, crop management practices as in planting direction, topographically induced effects on temperature near ground level such as sun angle and the slope's orientation as well as the soil color.

In meteorology, windward and leeward are technical names describing the wind directions from a point of reference where the windward side of an obstacle is facing the prevailing wind (upwind). Consequently, leeward describes the opposite, i.e. the side that is positioned away and therefore sheltered from the wind. Windward and leeward cause different orographic effects. On windward sides of topographical obstacles air masses are forced to rise which then again results in a decrease in temperature. The temperature decrease with an increase in altitude is described by the (vertical) adiabatic temperature gradient or lapse rate. This gradient is negative unless in case of inversion. When reaching the level of condensation the process of cloud formation begins until precipitation which is called orographic precipitation. Following this process, windward facing areas are relatively cooler and have more clouds and rainfall. On the contrary, leeward sides are sunnier, dryer and warmer in general.

The proximity of water bodies in windward direction to a point of reference influences the weather in regards of air humidity. Air masses flowing from water bodies are carrying more moisture which increases air humidity influencing crop development as well as crop disease spreading.

Types of land cover/land use include, among others, forest areas and woodlands, agricultural areas, grassland, irrigated areas, deserts and urban areas, with many more possible subdistinctions in functions and of course size. Different land use forms show different albedo affecting the local radiation balance. Albedo describes the amount of diffusive reflection of solar radiation out of the total solar radiation received by a body. It is dimensionless and measured on a scale from zero to one whereas a black body absorbs all incident radiation (albedo=0). The uneven heating of the surface from albedo variations caused by different land covers can drive weather. Small scale land cover changes such as in-field elements or field surroundings like trees and hedges can influence near ground wind fields. Those natural obstacles force a change in wind direction and wind speed and can also intentionally function as wind breaks. Near ground wind fields can also be influenced by field specific crop management practices as crop row direction.

Topographically induced effects on the radiation balance and temperature near ground level are caused by the sun angle, the slope's orientation as well as the soil color. The sun angle is the angle at which the sunlight hits the Earth which varies by location, time of day and the season. The direct effect of the sun angle on climate is the amount of solar radiation that is received at a point of interest at any location on the globe. In a lower sun angle the energy of the sunlight is spread over a larger area resulting in cooler temperatures. Similarly, the slope's orientation influences the local radiation balance. North-facing slopes in the southern hemisphere and south-facing slopes in the northern hemisphere receive more sunlight than the opposite slopes. In case of fallow lands the soil color also contributes to the above described albedo effect, as darker soil absorbs more of the incoming radiation and lighter soil reflects more energy.

In sum, all the described environmental influence factors have effects on wind fields and radiation balance/temperature. Digital information regarding topography, land cover/land use and soil are available in different manners. Topography information is obtained by digital elevation models (DEM). A digital elevation model is a digital model or 3D representation of a surface. Various DEMs in different spatial resolution are available. As described above, altitude has effects on local weather by influencing temperature, precipitation and wind fields. In addition to that, altitude correction of the climate model output is necessary in order to e.g. transform the given output temperature at 2 m above sea level to the actual temperature at a given altitude. With the aid of a DEM, mountain shadowing effects can be considered. Usable data layers, for example, SRTM in 30 m spatial resolution or LIDAR DTM in 5 m spatial resolution. Elevation data can be used to derive windward sides of an elevation, the slope's orientation as well as canopy height information.

Along with digital elevation it is also helpful to consider land cover/land use effects. Information regarding land cover/land use is provided by various data services. Data sets are, for example, ATKIS (Amtliches Topographisch-Kartographisches Informationssystem), for Germany, CORINE Land Cover=CLC (Coordination of Information on the Environment) in 30 m resolution for the EU and GlobCover Land Cover Maps, global, 250 m resolution. Normally, land cover/land use information is categorized in classes differentiating forests, agricultural areas, water bodies and urban areas. Further differentiation depends on the data set. For example, CORINE includes 44 classes describing the land cover and further differentiates between different types of agricultural land, as non-irrigated arable land, pastures and more. Possible parameterization of those data layers will include the influence of land cover/land use on the wind profile and therefore result in various parameters indicating the roughness of the surface. Location of water bodies can be derived from land cover maps or detected with analyzing remote sensing products. Soil color, if not indicated in soil maps, can also be derived with the aid of satellite imagery.

It is also an option also to consider in-field data such as in-field natural elements or crop management practices. These may be derived with expert's input, a possible expert being a farmer.

All these environmental parameters are gathered in step S2a and considered for small-scale relief effects, i.e. for regionalization in a less sparse grid than the global forecast data layer of a 13 km×13 km grid as described above (step S2b). According to the preferred embodiment described here, grid pointes distances down to 100 m are used.

In stage 3, according to the preferred embodiment of the invention, a deviation between the forecast data (stage 1) and ground truth data from agricultural in-field-weather stations is computed (step S3a). This is done to correct biases from the forecast obtained in step one and make the most accurate predictions by learning from ground truth data (step S3b). At this stage, according to the preferred embodiment of the invention, a machine learning model is used to find correlations between weather deviation and potential causes for the deviation. Machine learning, is relatively robust to perturbations and does not require a complete understanding of the physical processes that governs the atmosphere to understand how the weather predictions were made by forecast models like ICON. Therefore, a machine learning approach provides spatiotemporal inferences about weather.

According to the preferred embodiment of the invention, TensorFlow may be used for this purpose. TensorFlow is an open-source software library for dataflow programming across a range of tasks. It is a symbolic math library, and is also used for machine learning applications such as neural networks. TensorFlow was developed by the Google Brain team for internal Google use. It was released under the Apache 2.0 open source license on Nov. 9, 2015. An alternative to TensorFlow may be the Scikit-learn library.

With reference to identifying correlations it is not effective to explore only one variable at a time, instead, according to the preferred embodiment of the invention, the joint spatiotemporal statistic of multiple weather parameters and phenomena are explored. Also, it is helpful to model long-range spatiotemporal dependencies. Therefore, the machine learning model according to the preferred embodiment of the invention is configured as follows.

The model according to the preferred embodiment of the invention is able to identify and learn from recurring region specific weather patterns over time and make future prediction (temporal mining). Further, the dynamic influence of atmospheric laws/rules on weather phenomena are accounted for in the predictions (spatial interpolation). As a final step, the local interdependencies between weather variables and other environmental and crop specific factors are captured by the model according to the preferred embodiment of the invention (inter-variable interaction).

Weather data is a huge dataset and therefore requires “big data” storage and querying technologies to handle and process this data. A varied array of machine learning algorithms is suitable to capture the variations in the dataset. Given the huge dimensionality of this data it is helpful to start the process by carrying out a dimensionality reduction process. This is followed by investigations of algorithms ranging from supervised to unsupervised machine learning algorithms or a combination of both. To capture the inter-relationship between parameters simple algorithms like regression models, Gaussian processes, Markov models or kriging may be used according to the preferred embodiment of the invention.

Due to the recent success of artificial neural networks (ANN) in understanding and learning from examples, such ANNs may also be deployed according to the preferred embodiment of the invention. Further, deep learning may be used which is provided by an ANN with multiple layers. Flavors of deep learning architectures such as deep neural networks, deep belief networks, recurrent neural networks, long short-term memory and multilayer kernel machine may all be used according to the preferred embodiment of the invention. At the end of stage 3 regionalized and corrected data layer at a resolution of about 100 m×100 m may be achieved, after starting out at a resolution of 13 km×13 km.

To go from this stage to a field specific stage, according to the preferred embodiment of the invention, in stage 4, starting from above mentioned regionalized and corrected data layer at a resolution of about 100 m×100 m (step S4a) a crop model is used (step S4b) to obtain crop specific qualities like growth stage, roughness, soil evaporation, plant transpiration etc. (step S4c) and combine this with weather forecasts to get field zone specific weather forecasts (step S4d).

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope. Further, for the sake of clearness, not all elements in the drawings may have been supplied with reference signs.

1. A method for training a machine learning algorithm, comprising the following method steps:
feeding the machine learning algorithm with a predicted weather dataset that comprises at least one predicted value for at least one weather data variable for at least one instant of time and for at least one grid point of a first grid covering at least a part of the Earth's surface,
feeding the machine learning algorithm with an observed environmental dataset that comprises at least one ground truth value for at least one environmental data variable for the said at least one instant of time and for at least one grid point of a second grid covering at least the said part of the Earth's surface, and
feeding the machine learning algorithm with an observed weather dataset that comprises at least one ground truth value for the said at least one weather data variable for the said at least one instant of time and for at least one grid point of a third grid covering at least the said part of the Earth's surface.

2. The method according to claim 1, wherein the second grid is less sparse than the first grid.

3. The method according to claim 1, wherein the first grid and the third grid have common grid points.

4. The method according to claim 1, wherein the said at least one grid point of the first grid is different from the said at least one grid point of the second grid.

5. The method according to claim 1, wherein the predicted weather dataset comprises predicted values for multiple weather data variables for multiple instants of time and for multiple grid points of the first grid,
the observed environmental dataset comprises multiple ground truth values for multiple environmental data variables for the said multiple instants of time and for multiple grid points of the second grid, and
the observed weather dataset comprises multiple ground truth values for the said multiple weather data variables for the said multiple instants of time and for multiple grid points of the third grid.

6. The method according to claim 1, wherein the predicted weather dataset is based on a numerical weather prediction model.

7. The method according to claim 1, wherein the observed environmental dataset is based on an in-situ measurement and/or on capturing radar and/or satellite images.

8. The method according to claim 1, wherein the weather data variable of the predicted weather data set and the weather data variable of the observed weather data set are at least one of air temperature, air pressure, humidity, near-ground wind speed and/or direction.

9. The method according to claim 1, wherein the at least one ground truth value for at least one environmental data variable of the observed environmental dataset is at least one of air temperature, air pressure, humidity, near-ground wind speed and/or direction, type of land cover and use, crop management practice, sun angle, topographic data, and soil color.

10. A method for predicting a value for at least one weather data variable for at least one instant of time in the future, comprising the following method steps:
feeding a machine learning algorithm with a predicted weather dataset that comprises at least one predicted value for the said at least one weather data variable for the said at least one instant of time in the future and for at least one grid point of a first grid covering at least a part of the Earth's surface,
feeding the machine learning algorithm with an observed environmental dataset that comprises at least one ground truth value for at least one environmental data variable for at least one grid point of a second grid covering at least the said part of the Earth's surface, and
outputting by the machine learning algorithm a predicted value for the said at least one weather data variable for the said at least one instant of time in the future.

11. The method according to claim 11, wherein the at least one ground truth value for the said at least one environmental data variable for the said at least one grid point of the second grid is determined in real-time.

12. The method according to claim 10, wherein the machine learning algorithm has been trained according to the method of claim 1 beforehand.

13. A non-transitory computer-readable medium, comprising instructions stored thereon, that when executed on a processor, perform the steps of the method according to claim 1.

14. A data processing system, comprising a processor and a non-transitory computer readable medium according to claim 13.
